(19) United States
(12) Patent Application Publication
(10) Pub. No.: US 2023/0385374 A1
(43) Pub. Date: Nov. 30, 2023

(54) SYSTEMS AND METHODS FOR SPARSE MATRIX MULTIPLICATION

(71) Applicant: Microsoft Technology Licensing, LLC, Redmond, WA (US)

(72) Inventors: Venmugil ELANGO, Redmond, WA (US); Bita DARVISH ROUHANI, Bellevue, WA (US); Eric S CHUNG, Woodinville, WA (US); Douglas Christopher BURGER, Bellevue, WA (US)

(73) Assignee: Microsoft Technology Licensing, LLC, Redmond, WA (US)

(21) Appl. No.: 17/657,912

(22) Filed: Apr. 4, 2022

(51) Int. Cl. G06F 17/16; G06N 3/08; G06N 3/04

(52) U.S. Cl. CPC G06F 17/16; G06N 3/08; G06N 3/0454

(57) ABSTRACT

A method for sparse matrix multiplication comprises receiving a first block having M elements in a first dimension, and parsing the first block of M elements into a first set of B sub-blocks including MB elements in the first dimension. A first sparsity mask having S % sparsity is applied to the first block of elements, such that each of the first set of B sub-blocks has S % sparsity. A second block is received having M elements in a second dimension, and is parsed into a second set of B sub-blocks that include MB elements in the second dimension. A second sparsity mask having S′% sparsity is applied to the second block of elements, such that S′% of the second set of B sub-blocks have 100% sparsity and (100−S′)% of the second set of B sub-blocks have 0% sparsity. The first and second blocks are then matrix multiplied.

### BACKGROUND

Deep neural networks (DNNs) may be used in machine learning to build artificial intelligence models. Deep learning workloads comprise input data, weight matrices that are learned during supervised training, and activation matrices that are computed from the input data and weight matrices. As computing resources expand, larger data sets can be processed, requiring the DNNs to be scaled up accordingly. Sparsity may be used as a tool to reduce the amount of compute and/or memory consumed for the operations required during training of a DNN and/or during inference when deploying a trained DNN.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for sparse matrix multiplication comprises receiving a first block having M elements in a first dimension and parsing the first block of M elements into a first set of B sub-blocks including MB elements in the first dimension. A first sparsity mask having S % sparsity is applied to the first block of elements, such that each of the first set of B sub-blocks have S % sparsity. A second block is received having M elements in a second dimension. The second block of elements are parsed into a second set of B sub-blocks including MB elements in the second dimension. A second sparsity mask having S′% sparsity is applied to the second block of elements, such that S′% of the second set of B sub-blocks have 100% sparsity and (100−S′)% of the second set of B sub-blocks have 0% sparsity. The first and second blocks are then matrix multiplied.

### BRIEF DESCRIPTION OF THE DRAWINGS

FIG. 1 schematically shows an example system for training a neural network.

FIG. 2 schematically shows an example of dense training of a neural network.

FIG. 3 schematically shows an example of sparsified training of a neural network.

FIG. 4 schematically shows simple matrix sparsification.

FIG. 5 schematically shows unstructured and balanced sparsity masks.

FIG. 6 schematically shows a method for matrix multiplication.

FIG. 7 schematically shows a method for sparse matrix multiplication.

FIG. 8 shows a flow-chart for a method of sparse matrix multiplication.

FIG. 9 schematically shows a method for sparse matrix multiplication of the current disclosure.

FIG. 10 schematically depicts an example computing system.

### DETAILED DESCRIPTION

Deep neural networks (DNNs) have grown exponentially in size over the past years to achieve greater accuracies. These large models lead to high computational costs during both training and inference. Sparsity is a common technique used to prune a model to reduce the number of parameters, thereby reducing its computational cost.

Sparsity may be implemented as structured sparsity or unstructured sparsity. Unstructured sparsity allows a high degree of freedom for pruning but often is not hardware friendly. Structured sparsity, on the other hand, can be efficiently implemented in hardware, but may lead to noticeable reduction in model accuracy.

Balanced sparsity is a specific kind of structured sparsity that provides a balance between structured and unstructured sparsity. For example, balanced sparsity may include simply taking each row in the matrix and then applying a percentage sparsity to the elements in row-wise fashion.

For fine-grained balanced sparsity, a tensor may first be tiled into multiple blocks of size ‘B’ each; (e.g., each row of the tensor matrix is divided into multiple smaller blocks of equal numbers of elements). Then, within each block, the same percentage sparsity is applied so that the same percentage of elements within each block are pruned. In this way, the sparsity is balanced across all blocks in each row. For inference, one-dimensional blocks (e.g., rows/columns) are commonly used. In training, the blocks may be two dimensional, as the weight matrix needs to be transposed for backpropagation. Multiple rows may be grouped together, with the same mask pattern applied to each row of the group, or a mask may be created for each row individually, with the row then divided into multiple blocks.

In order to achieve higher sparsity levels without significant loss in accuracy, and to reduce imbalances in loading the tensors, both weight and activation tensors may need to be pruned. For example, 50% sparsity may be applied to a weight matrix, and 50% sparsity may be independently applied to the corresponding activation matrix to achieve an average combined sparsity of 75% during a matrix-matrix multiplication (matmul) operation.

In this example, while the combined sparsity of the resulting matrix averages out to 75% across each block, the local block sparsity varies between 50% and 100% per block, depending on the amount of overlap between the pruning masks of weight and activation matrices.

When the combined sparsity is much higher than the expected average (e.g., close to 100%) within a block, a significant amount of information may be lost without any additional improvement to the computational cost in hardware. This may lead to a significant loss in accuracy. Conversely, when the combined sparsity is lower than the expected average, some of the additional non-zeros end up being deliberately dropped from computation by the hardware to keep the computational cost within the allocated budget. Thus, it is desirable to keep the level of sparsity within each block uniformly close to the average.

To reduce variability and achieve more uniform sparsity, systems and methods are presented herein where a first block as pruned using fine grained balanced sparsity and the second block is pruned using coarse-grained balanced sparsity. In this way, the resulting combined sparsity is uniformly achieved without any additional computational burden. For coarse-grained sparsity, the applied sparsity percentage is applied at the level of sub-blocks, rather than at the level of individual elements. By combining these together, the patterns of the two blocks are complementary in such a way that a desired percentage of elements are maintained from each block, without the risk of oversparsifying.

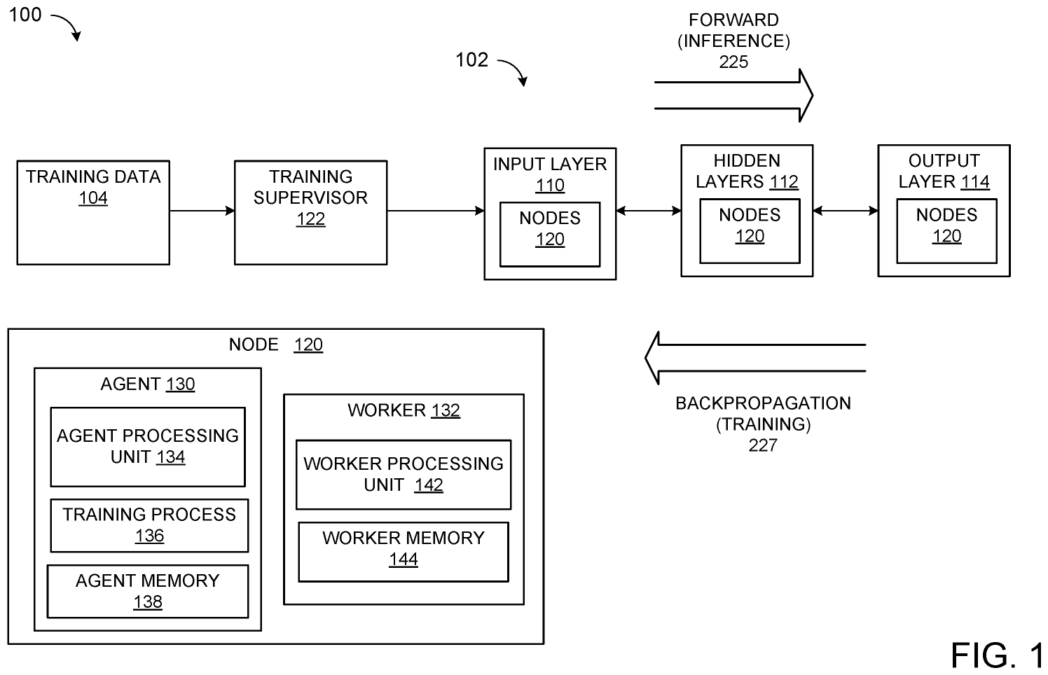

FIG. 1 shows an example system 100 for training of a neural network 102. In this example, training data 104 is used to train parameters of neural network 102, such as the weights and/or gradients of neural network 102. Training data 104 may be processed over multiple epochs to arrive at a final trained set of model parameters. As used herein, an “epoch” occurs when one full set of training data 104 has been processed once.

Neural network 102 includes an input layer 110, one or more hidden layers 112, and an output layer 114. Each layer includes a plurality of nodes 120. Training supervisor 122 may provide training data 104 to the input layer 110 of neural network 102. In some examples, training data 104 may be divided into minibatches and/or shards for distribution to subsets of inputs. Training supervisor 122 may include one or more network accessible computing devices programmed to provide a service that is responsible for managing resources for training jobs. Training supervisor 122 may further provide information and instructions regarding the training process to each node 120.

In this example, nodes 120 of the model receive input values on input layer 110 and produce an output result on output layer 114 during forward processing, or inference (125). During training, the data flows in the reverse direction during backpropagation (127), where an error between a network result and an expected result is determined at the output and the weights are updated layer by layer flowing from output layer 114 to input layer 110.

Each node 120 may include one or more agents 130 configured to supervise one or more workers 132. In general, each node 120 contains multiple workers 132, and an agent 130 may monitor multiple workers. Each node may further contain multiple agents 130. Nodes 120 may be implemented using a central processing unit (CPU), a graphics processing unit (GPU), a combination of CPUs and GPUs, or a combination of any CPUs, GPUs, ASICs, and/or other computer programmable hardware. Agents 130 and workers 132 within a common node 120 may share certain resources, such as one or more local networks, storage subsystems, local services, etc.

Each agent 130 may include an agent processing unit 134, a training process 136, and an agent memory 138. Each worker 132 may include a worker processing unit 142 and a worker memory 144. Generally, agent processing units 134 are described as being implemented with CPUs, while worker processing units 142 are implemented with GPUs. However other configurations are possible. For example, some or all aspects may additionally or alternatively be implemented in cloud computing environments. Cloud computing environments may include models for enabling on-demand network access to a shared pool of configurable computing resources. Such a shared pool of configurable computing resources can be rapidly provisioned via virtualization, then scaled accordingly. A cloud computing model can be composed of various characteristics such as, for example, on-demand self-service, broad network access, resource pooling, rapid elasticity, measured service, and so forth.

Deep learning models (or “networks”) comprise a graph of parameterizable layers (or “operators”) that together implement a complex nonlinear function. The network may be trained via a set of training data that comprises of pairs of input examples (x) and outputs (y). The desired output is a learned function that is parameterized by weights (w), such that given an input (x), the prediction ƒ(x; w) approaches (y).

Applying the function ƒ(x; w) is performed by transforming the input (x) layer by layer to generate the output—this process is called inference. In a training setting, this is referred to as the forward pass. Provisioning a network to solve a specific task includes two phases—designing the network structure and training the network's weights. Once designed, the network structure is generally not changed during the training process.

Training iterations start with a forward pass, which is similar to inference but wherein the inputs of each layer are stored. The quality of the result ƒ(x; w) of the forward pass is evaluated using a loss function € to estimate the accuracy of the prediction. The following backward pass propagates the loss (e.g., error) from the last layer in the reverse direction. At each parametric (e.g., learnable) layer, the backward pass uses the adjoint of the forward operation to compute a gradient g and update the parameters, or weights using a learning rule to decrease €. This process is repeated iteratively for numerous examples until the function ƒ(x; w) provides the desired accuracy.

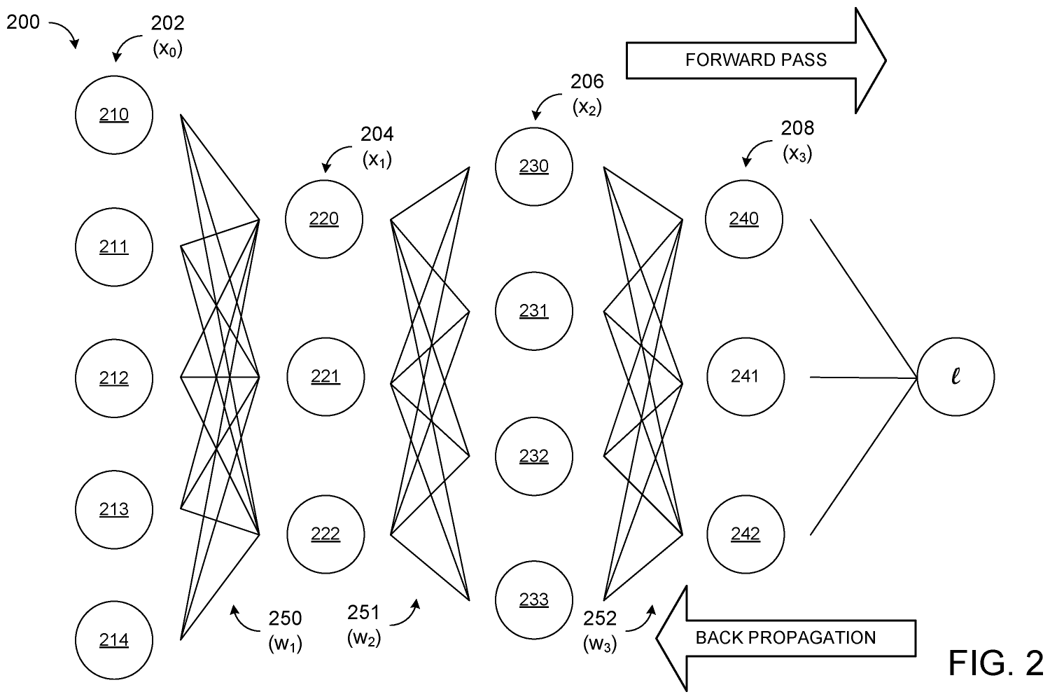

As an example, FIG. 2 schematically shows a multilayer neural network 200, including an input layer (x₀) 202, two hidden layers (x₁) 204 and (x₂) 206, and an output layer (x₃) 208. In this example, input layer 202 includes 5 neurons (210, 211, 212, 213, 214), first hidden layer 204 includes 3 neurons (220, 221, 222), second hidden layer 206 includes 4 neurons (230, 231, 232, 233), and output layer 208 incudes 3 neurons (241, 242, 243).

Neural network 200 includes activation functions, such as rectified linear units (not shown). Neural network 200 may be parameterized by weight matrices w₁ 250, w₂ 251, and w₃ 252 and bias vectors (not shown). Each weight matrix includes a weight for each connection between two adjacent layers. The forward pass may include a series of matrix-vector products ƒ (x0; w), where x₀ is the input or feature vector.

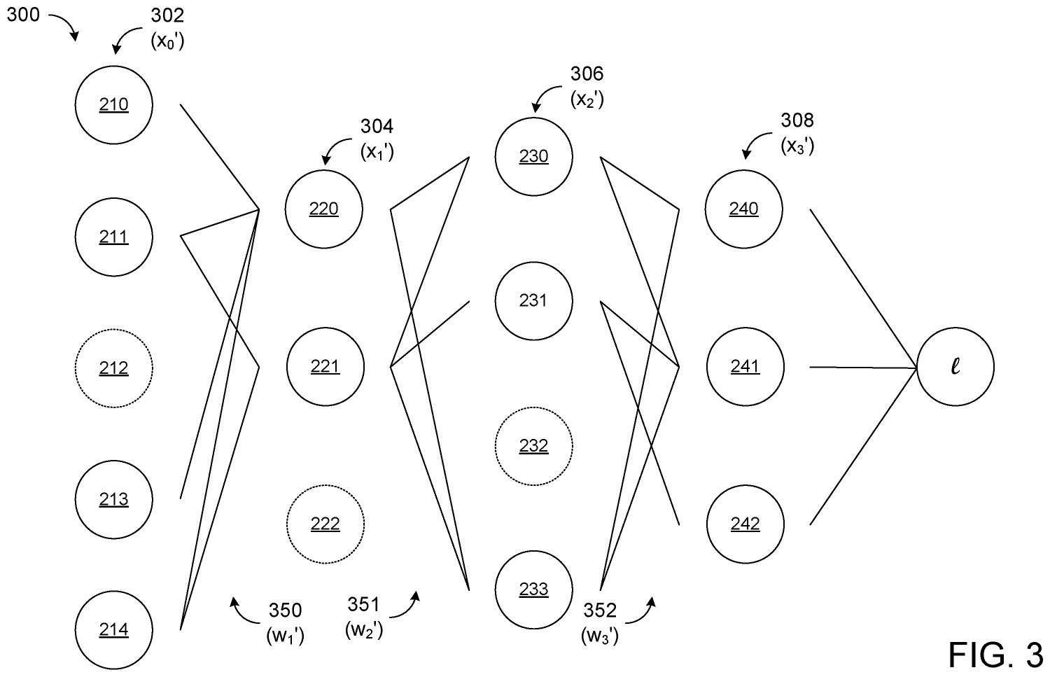

The sizes of deep neural networks such as network 200 are rapidly outgrowing the capacity of hardware to fast store and train them. Sparsity may be applied to reduce the number of network parameters before, during, and after training by pruning edges from the underlying topology. FIG. 3 shows a sparsified version 300 of network 200, comprising hidden layer input layer (x₀′) 302, hidden layers (x₁′) 304 and (x₂′) 306, and output layer (x₃′) 308. In this example, the third input feature 212 and all of its adjacent weights are removed (dashed lines) from input layer (x₀′) 302. Additionally, hidden neurons 222 and 232 and their weights are removed from hidden layers (x₁′) 304 and (x₂′) 306, respectively. Various other weights have been removed from sparsified version 300, yielding weight matrices (w₁′) 350, (w₂′) 351, and (w₃′) 352. Removing neurons or input features in this way corresponds to removing rows or columns in the layer weight matrices. Removing individual weights corresponds to removing individual elements of the weight matrices. Sparsity may be induced or arise naturally, and may be applied to other tensors and matrices, such as matrices for activation, error, biases, etc.

For activations, shutting off an activation for a node essentially generates a zero output. Sparsity as applied to activations may work the same, e.g., activations that are a higher magnitude are of higher value to the network and are retained. In some examples, the activations approach sparsity naturally, so true sparsity can be added with modest impact. During inference, the activation matrix changes during each pass as new data is introduced into the neural network. As such, the pruning metric may be applied during each pass, then a new mask computed based on that calculation.

Sparsifying a weight matrix, or other matrix or tensor, effectively reduces the complexity of matrix multiplication events utilizing that matrix. Generally, the speed of matrix multiplication directly correlates to the sparsity of the matrix. Applying 75% sparsity to a weight matrix and 0% sparsity for activations can speed up the process on the order of 4×. Another way to accomplish 4× speed increase is applying 50% of sparsity to activations and 50% sparsity to weights. A balance can thus be made by distributing sparsity between weights and activations.

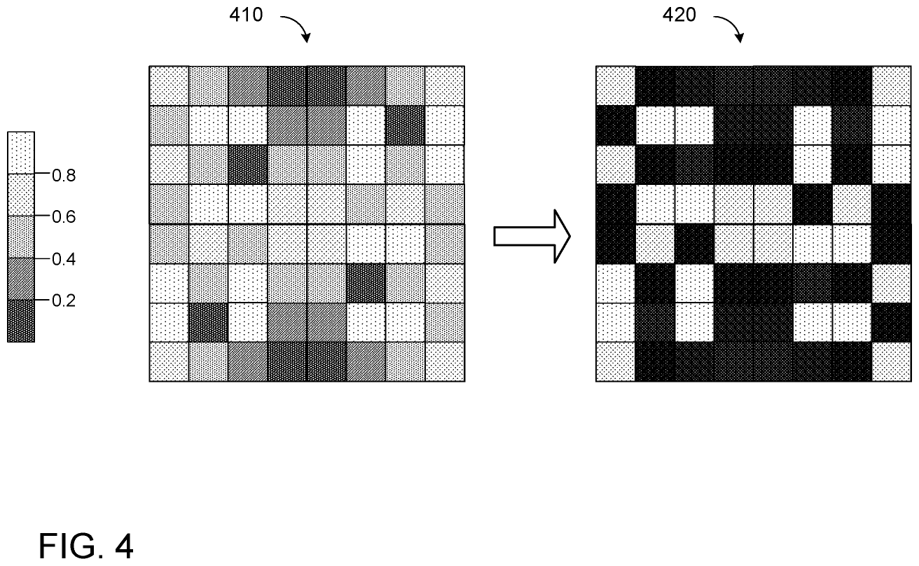

For example, in FIG. 4, a heat map 410 of an 8×8 weight matrix that is going to be sparsified is shown. Lighter shaded blocks represent higher values. A simple high pass filter may be applied to take the highest values to form a sparsified matrix 420. However, using simple filtering like this leaves imbalanced rows and columns. So, while effective at reducing the complexity of any subsequent matrix multiplication, a more deliberate approach to sparsity may simplify the matrix even more, allowing for more targeted matrix compression.

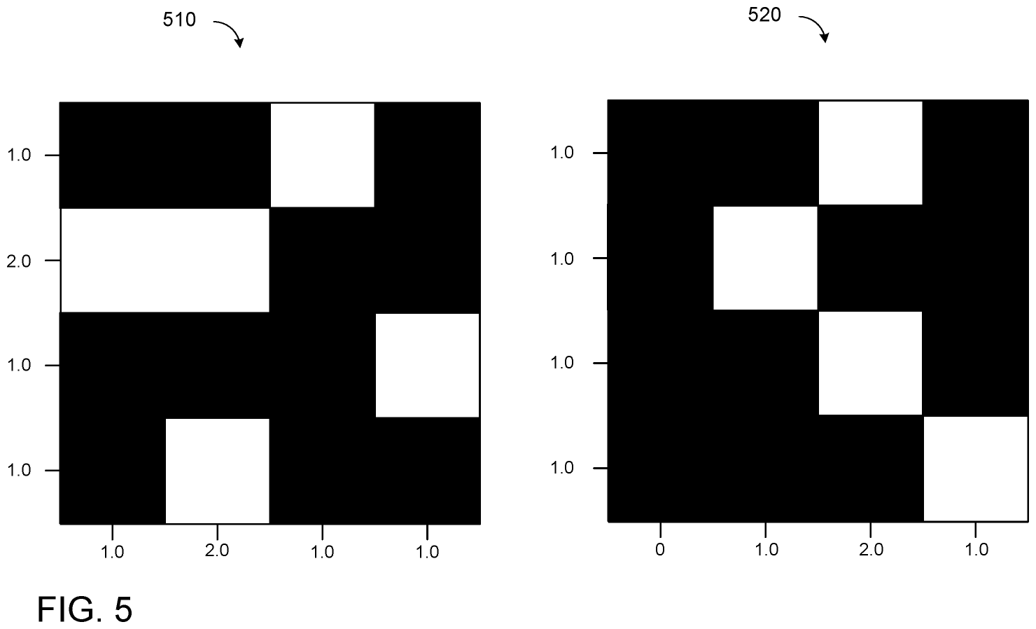

For unstructured sparsity, the mask has few constraints, and can essentially be configured in any random pattern. In FIG. 5, mask 510 is an example of unstructured sparsity. Each black square masks the underlying value to 0. Each white square allows the underlying value to be non-zero (e.g., the assigned value). The numbers on the axes of the grid are the counts for that row or column—e.g., how many non-zero values are present in that dimension. For example, the topmost row of mask 510 has one white square (non-zero value) and the second column from the left of mask 510 has two white squares (non-zero values). This convention is used throughout this disclosure.

Unstructured sparsity is generally applied after a network is trained but can also be applied during training in some circumstances. Unstructured sparsity is the least constraining form of sparsity, but its inherent randomicity makes it difficult to accelerate on the hardware level. The size of each sparsity block is equal to size of the tensor. As block size increases, so does fidelity, as different configurations can be represented with more flexibility. However, there are diminishing returns as block size increases past a threshold.

The most common constraint on balanced sparsity is N of M constraints. Therein, for a column or row that has M values, only N (N<M) can be non-zero. For example, mask 520 is an example of balanced sparsity with a value of N=1. Each row of mask 520 has one white square (non-zero value). The columns of mask 520 range from 0 to 2 non-zero values.

Balanced sparsity is thus more constrained than unstructured sparsity but is easier to accelerate with hardware because the hardware can anticipate what to expect from each constrained row or column. The known constraints can be pre-loaded into the hardware. For balanced random fine grained sparsity, “fine grained” means that only a portion of the tensor is sparsified, while balanced means that all blocks (e.g., rows, columns) have the same level of sparsity, but within each block the pattern is random.

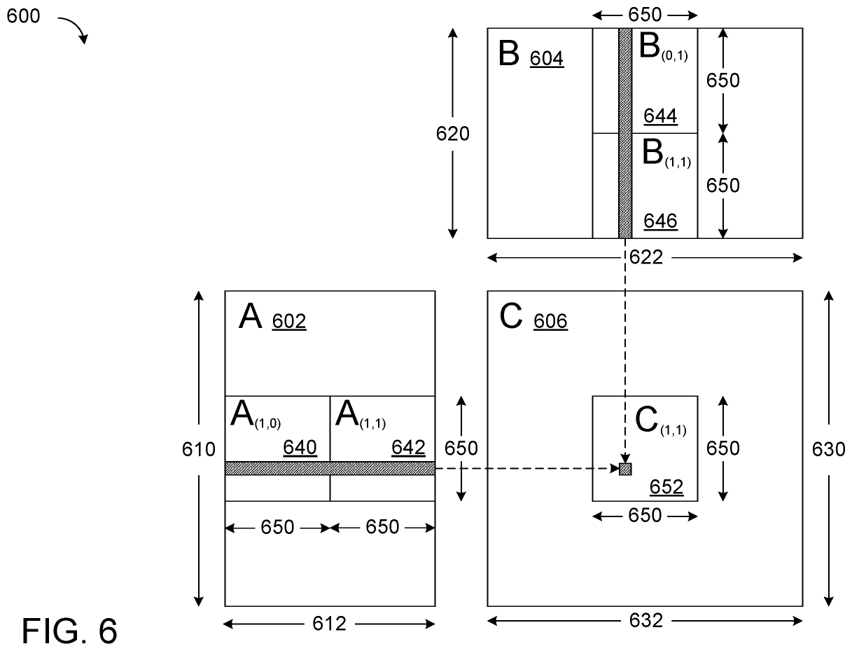

Pruning matrices saves compute and memory during the many matrix multiplications (matmul) performed over the course of executing a neural network, be it during training, fine-tuning, or inference. FIG. 6 schematically shows a method 600 for matrix multiplication. A first matrix (A) 602 is multiplied by a second matrix (B) 604 to yield a third matrix (C) 606.

First matrix (A) 602 is characterized by a height 610 and a width 612 based on a number of matrix elements. Second matrix (B) 604 has a height 620 and a width 622. In general, the interior dimensions (here the width 612 of first matrix (A) and the height 620 of second matrix (B)) are set to an equal number of matrix elements such that multiplying first matrix (A) 602 and second matrix (B) 604 yields third matrix (C) 606 having a height 630 and a width 632 that are equal in dimensions to width 612 of first matrix (A) 602 and height 620 of second matrix (B) 604. The height 610 of first matrix (A) 602 and width 622 of second matrix (B) 604 are not constrained to be of equal dimensions. First matrix (A) 602 and second matrix (B) 604 may represent an activation matrix and a weight matrix, or other combinations of matrices.

For the matmul to be implemented into hardware, the matrices are generally broken into smaller, more uniform submatrices. As shown, first matrix (A) 602 includes at least first sub-block A_{(1,0)} 640 and second sub-block A_{(1,1)} 642, while second matrix (B) 604 includes at least first sub-block B_{(0,1)} 644 and second sub-block B_{(1,1)} 646, each having a block size 650. In this example, the sub-blocks are square, having equal heights and widths. However, as will be described further herein, the sub-blocks may alternatively be rectangular or linear.

As such, when the matrix multiplication is performed, first sub-block A_{(1,0)} 640 gets multiplied by first sub-block B_{(0,1)} 644, and sub-block C_{(1,1)} 652 of third matrix (C) 606 gets updated. During the next iteration, second sub-block A_{(1,1)} 642 gets multiplied by second sub-block B_{(1,1)} 646, and sub-block C_{(1,1)} 652 of third matrix (C) 606 gets further updated.

This particular blocking scheme is not specific to sparsity; rather this blocking scheme may be implemented within the hardware itself. An additional level of blocking may be used to implement sparsity, wherein each sub-block is broken down into smaller sparsity blocks for masking.

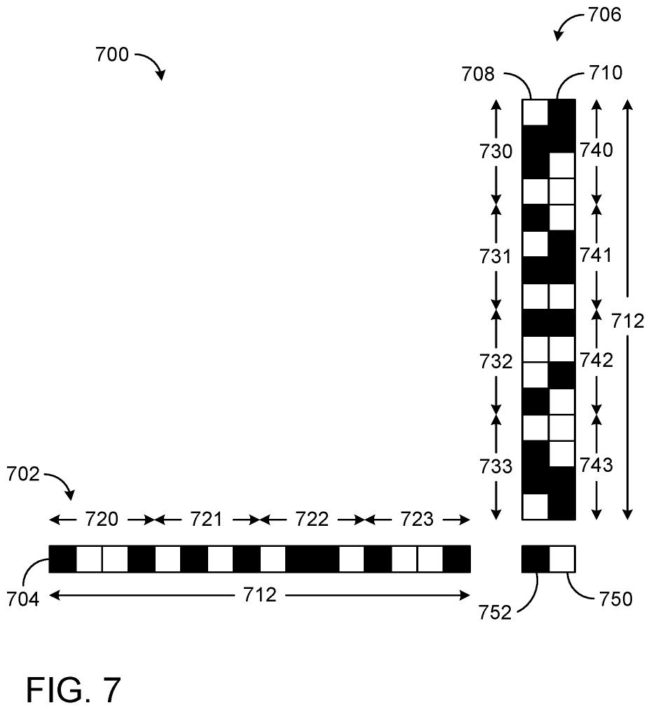

As one example, FIG. 7 shows a scenario 700 for matrix multiplication. A first sparsity mask 702 is shown for a first block of elements 704, and a second sparsity mask 706 is shown for a second block of elements 708 and a third block of elements 710. Each block of elements has a block size (M) of 16, as indicated at 712. In this example, the blocks of elements are one-dimensional, but in other examples a block of elements may be two-dimensional, three-dimensional, or have greater dimensionality, e.g., if derived from a multi-dimensional tensor.

Each block of elements may then be broken into a second level of blocking for the application of sparsity. The amount of hardware overhead for implementing sparsity is proportional to the sparsity block size (B). As such, the sparsity block size (B) is generally smaller than the block size (M). Generally, the block size (M) is an integer multiple of the sparsity block size (B). In this example, the sparsity block size is set as B=4. As such, first block of elements 704 is divided into 4 sparsity blocks of size 4—sparsity blocks 720, 721, 722, and 723. Similarly, second block of elements 708 is divided into 4 sparsity blocks of size 4—sparsity blocks 730, 731, 732, and 733, and third block of elements 710 is divided into 4 sparsity blocks of size 4—sparsity blocks 740, 741, 742, and 743.

In this example, 50% sparsity is applied to each sparsity block on an element-wise basis (e.g., fine-grained balanced sparsity). As such, each sparsity block includes two zero elements (black blocks) that prune the underlying value and two non-zero elements (white blocks) that maintain the underlying values.

Applying 50% sparsity to two blocks of elements in this way will average out to 75% sparsity of the matmul product given random distribution of the zero elements within each mask, as shown at 750 for the product of first block of elements 704 and third block of elements 710. However, when two blocks are masked in this fashion and then multiplied together, all of the information is lost whenever there is a 0 value in either block. As such, if the two blocks are completely complementary, such as first block of elements 704 and second block of elements 708, each multiplication includes a zero element, and thus the resulting product is 100% sparse, as shown at 752.

As such, the actual resulting sparsity may far exceed, or even undershoot the target sparsity. This eliminates a significant amount of information which cannot be recovered, leading to a loss of accuracy in downstream calculations. In this example, the target sparsity is 75%, but if the patterns of the two blocks were exactly the same, the resulting sparsity would be 50%. The random distribution of values means that the result could be anywhere from 50% to 100% resulting sparsity, and it is not possible to control that distribution.

Further, there is no computational or performance advantage to over-sparsifying. If the hardware is specifically designed to take advantage of 50% sparsity, it will not possess the logic to a dynamically determine if the calculation is 100% sparse. Instead of eliminating any matrix multiplication, it will still load a 0 here and a non 0 here, do the actual multiplication and then return zero anyways. As such, the overall computation cost remains the same, even at 100% sparsity.

To generate and maintain a uniform level of combined sparsity within each block of a matmul computation, two different sparsity patterns may be applied to the two components of the computation. One component may be pruned as shown in FIG. 7, with a pattern of fine-grained balanced sparsity. The second component may alternatively be pruned with a different level of granularity, using a pattern of coarse-grained balanced sparsity. This allows for a desired combined level of sparsity to be reached, while also ensuring that some non-zero data is preserved within each block.

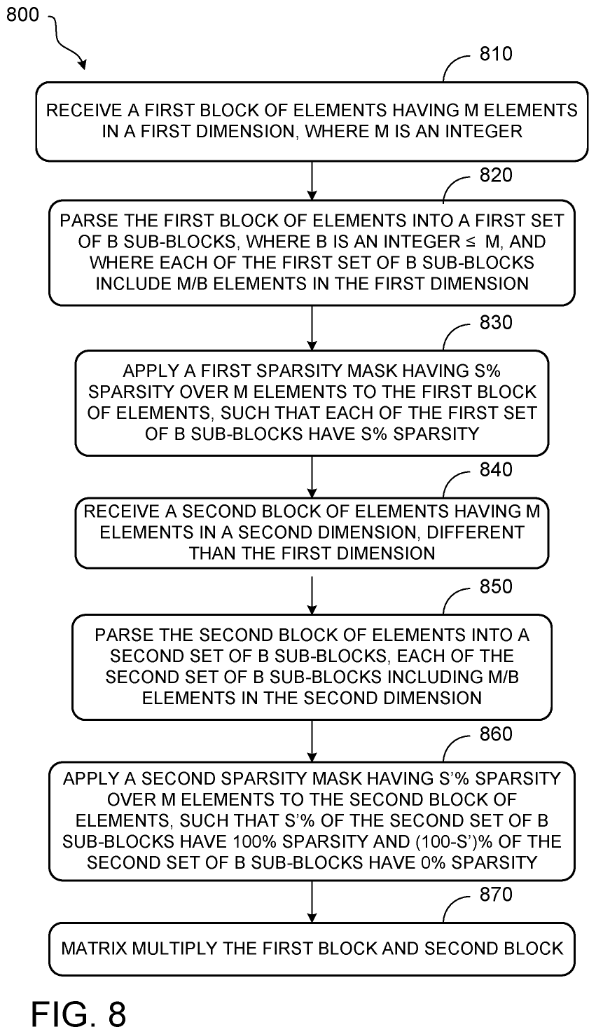

FIG. 8 shows a method 800 for sparse matrix multiplication. Method 800 may be executed by one or more computing systems, such as systems 100 and/or 200. Method 800 may thus be implemented as part of training a neural network, fine-tuning a neural network, performing an inference operation with a trained neural network, as part of a self-attention layer of a transformer language model, and/or during any computational procedure where blocks of elements derived from matrices are pruned prior to performing a matmul operation. By using masks with differing sparsity patterns (e.g., different granularities) on components of a matmul operation, the combined sparsity following the matmul operation may be uniform at the block level. The technical effect of implementing such a method is a reduction in the use of computing resources.

At 810, method 800 includes receiving a first block of elements having M elements in a first dimension, where M is an integer. For example, a matrix containing one or more blocks of M elements may be loaded from a main memory to a suitable cache. For the purpose of this example, the first block of elements will be described as belonging to a weight matrix, but may alternatively be block of activations, gradients, biases, or other matrix elements. The block of elements may be one dimensional, two dimensional, or three or more dimensional. In this example, the element blocks will be described as one dimensional, such as a row or elements, a column of elements, and/or a partial row or column of elements, as described with regard to FIGS. 6 and 7.

At 820, method 800 includes parsing the first block of elements into a first set of B sub-blocks, where B is an integer <M, and where each of the first set of B sub-blocks include MB elements in the first dimension. In most cases, M is an integer multiple of B. In general, once the block size M and sparsity block size B are selected, the hardware is designed to operate on the selected block sizes. However, M and B are not necessarily fixed and could be changed during runtime for inference or training, particularly as virtual machines are implemented.

At 830, method 800 includes applying a first sparsity mask having S % sparsity over M elements to the first block of elements, such that each of the first set of B sub-blocks have S % sparsity. As such, the first sparsity mask may be a fine grained balanced sparsity mask. To determine which of the elements are pruned for sparsity, a pruning metric may be applied. In one example, S % of each set of MB elements having the lowest L1-norms may be pruned. Additionally or alternatively, the absolute magnitude of each respective set of elements may be determined, and the lowest S % pruned.

At 840, method 800 includes receiving a second block of elements having M elements in a second dimension, different than the first dimension, where M is an integer, generally the same integer M as described at 810. For example, the first dimension may be a column and the second dimension may be a row, or vice-versa. Continuing the example, where the first block of elements was derived from a weight matrix, second block of elements may be an activation matrix. Continuing at 850, method 800 includes parsing the second block of elements into a second set of B sub-blocks, each of the second set of B sub-blocks including MB elements in the second dimension. In this example, the sub-blocks are equal in size and number, but in other examples, one block of elements may be subdivided into a different pattern of sub-blocks than the other block of elements.

At 860, method 800 includes applying a second sparsity mask having S′% sparsity over M elements to the second block of elements, such that S′% of the second set of B sub-blocks have 100% sparsity (e.g., pruned) and (100−S′)% of the second set of B sub-blocks have 0% sparsity (e.g., fully dense) (e.g., coarse-grained balanced sparsity). In some examples, S′ may be equal to S, but in other examples they are different. The metric used to prune S′% of the second block of elements may be the same metric as the metric for S, but in other examples the metrics may be specifically determined on the matrix type, an expected distribution within the block, etc. S and S′ may be determined based on a desired combined sparsity. For example, a desired combined sparsity of 75% may be produced by applying 50% sparsity to both the first and second blocks.

At 870, method 800 includes matrix multiplying the first block and second block. By applying fine-grained sparsity to the first block (e.g. weights) and applying coarse-grained sparsity to the second block (e.g., activations), the first and second blocks will have completely different sparsity patterns. While each corresponding pairs of sub-blocks may have different levels of sparsity, the differing patterns generate a combined sparsity in the matmul product that is deterministically uniform throughout the product (e.g., the same or within a threshold similarity for each block) without adding any computational cost, thus leading to increased model accuracies at the same cost.

In this way, a different level of sparsity granularity may be applied to the two matrices being multiplied thus guaranteeing a desired level of total sparsity of the resulting matmul product. This allows for the sparsity generation at the software level to be tuned to the hardware configuration to generate efficient matmul operations, while still maintaining relatively inexpensive computations for pruning a given percentage of elements. In other words, other sparsity patterns could be applied that achieve a similar result, but may take significant computations to generate two masks that are complementary in this way. In contrast, this method is fast, inexpensive, globally applicable, and tunable.

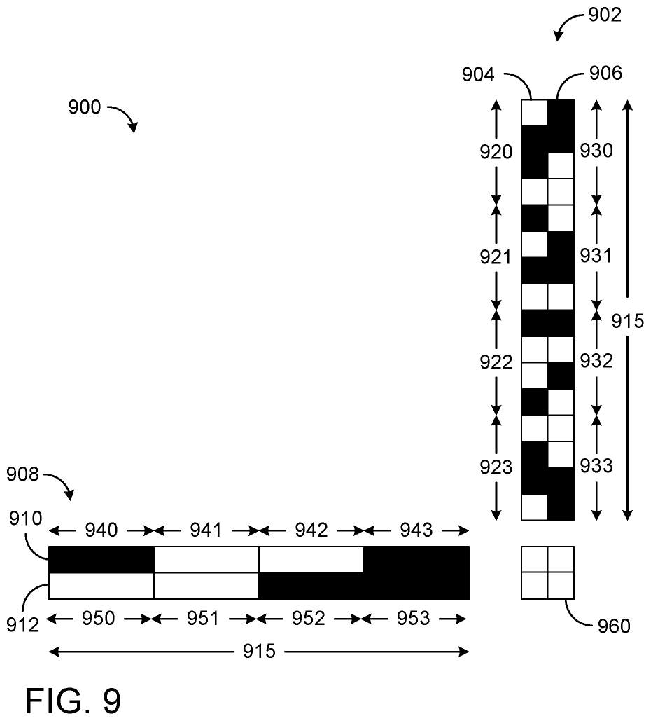

As one example, FIG. 9 shows a scenario 900 for sparse matrix multiplication. A first sparsity mask 902 is shown for a first block of elements 904 and a second block of elements 906 derived from a first matrix. A second sparsity mask 908 is shown for a third block of elements 910 and a fourth block of elements 912 derived from a second matrix. Each block of elements has a block size (M) of 16, as indicated at 915. Each block of elements is then be broken into a second level of blocking (B) for the application of sparsity. In this example, the sparsity block size is set as B=4. As such, first block of elements 904 is divided into 4 sparsity blocks of size 4—sparsity blocks 920, 921, 922, and 923. Similarly, second block of elements 906 is divided into 4 sparsity blocks of size 4—sparsity blocks 930, 931, 932, and 933; third block of elements 910 is divided into 4 sparsity blocks of size 4—sparsity blocks 940, 941, 942, and 943; and fourth block of elements 912 is divided into 4 sparsity blocks of size 4—sparsity blocks 950, 951, 952, and 953.

In this example, first sparsity mask 902 is used to apply 50% sparsity to each sparsity block of first block of elements 904 and second block of elements 906 on an element-wise basis (e.g., fine-grained balanced sparsity). As such, each of sparsity blocks 920, 921, 922, 923, 930, 931, 932, and 933 include two zero elements (black blocks) that prune the underlying value and two non-zero elements (white blocks) that maintain the underlying values.

In contrast, second sparsity mask 908 is used to apply 50% sparsity to third block of elements 910 and fourth block of elements 912 on a sparsity block-wise bases (e.g., coarse-grained balanced sparsity). As such, sparsity blocks 940, 943, 952, and 953 each include four zero elements, pruning the underlying values of each sparsity block while sparsity blocks 941, 942, 950, and 951 each include four non-zero elements, maintaining the underlying values of those sparsity blocks.

By masking in this fashion, when first block of elements 904 and second block of elements 906 are matrix-multiplied by third block of elements 910 and fourth block of elements 912, the resulting combined sparsity for each pair of blocks is exactly 75%. For instance, when first block of elements 904 is matrix-multiplied by third block of elements 910, since the sub-blocks 940 and 943 are completely zero, matrix-multiplication of sub-block 940 with 920, and matrix-multiplication of sub-block 943 with 923 can be entirely eliminated. Additionally, since sub-blocks 921 and 922 are 50% sparse, matrix-multiplication of sub-block 941 with 921, and matrix-multiplication of sub-block 942 with 922 would only involve 50% of computation. In total, only four out of 16 pair of elements in blocks 910 and 904 have to be multiplied to obtain the resultant value in block 960, providing a combined sparsity of 75%.

Effectively, each sparsity block of the first block of elements is either multiplied by a zero or non-zero value from the corresponding sparsity block of the second block of elements. The relative sparsities may thus average out over the size of the first and second blocks of elements. In the example of 50% activation sparsity and 50% weight sparsity, each matmul block achieves a combined sparsity of exactly 75%. In general, when fine-grained balanced sparsity of x % is applied to one of the two matrices that are multiplied together, and y % coarse-grained sparsity is applied to the other, the combined sparsity within each matmul block is exactly (x+y−((x*y)/100)%.

During training, both the activation and the weight matrices are dynamically changing, e.g., during each forward phase there will be new elements in the activation matrix and each backpropagation updates the weight matrix. The overall sparsity levels may be set as a constant, or may change progressively over training (e.g., decreasing step-wise based on model performance).

However, during inference, the weight matrix is fixed based on training. The activation matrix, which depends on the user input, is calculated newly for each forward phase based on the newly input data. The dimensions and size of the activation matrix may essentially stay the same, but the individual elements are different for each forward phase. As such, during inference, when the sparsity masks are computed, the masks for the weight matrix may be reused or maintained (e.g., static), but the masks for the activation matrix may be dynamically recomputed for each forward phase (e.g., dynamic).

These sparsity patterns apply generally for all matrix multiplications. As such, in neural networks, these methods also apply to cases where both matrices include activations (e.g., the self-attention layer in transformer language model). A fine-grained sparsity mask may be applied to one activation matrix, and a coarse grained sparsity mask may be applied to the other activation matrix. As another example, during back propagation iterations during training, one matrix may be a gradient matrix, and the second matrix may be either an activation matrix or a weight matrix.

In general, the examples herein describe activations as receiving coarse grained sparsity, and weights receiving fine grained sparsity, but in terms of hardware performance, this pattern could be reversed with no significant effects. However, in practice, specifically for language modeling tasks, it has been noted that for activations, oftentimes consecutive elements have very similar magnitudes. In other words, the low magnitude elements are clustered together (e.g., consecutive elements in a row) and the higher magnitude elements are clustered together elsewhere. In contrast, weights have a more random distribution. As such, this particular pattern of applying coarse grained sparsity for activation and fine grained sparsity for weights may more advantageous. However, other applications could have opposite patterns. As such, the condition of the application may be learned over time, so the sparsity patterns can be determined at the outset of a process and then maintained throughout.

It has been shown that the loss in accuracy due to sparsity can be reduced by minimizing the one-norm of the pruned values. One approach to achieve this for structured sparsity includes computing a permutation matrix that minimizes the pruned one-norm for each respective weight matrix using a greedy reordering technique. The weight matrices may then be permuted using these permutation matrices. Structured sparsity may then be applied on top of these permuted weight matrices. This process can be adapted to both fine-grained and coarse-grained balanced sparsity patterns to further increase the pruned accuracy. Matrix elements may thus be shuffled around so that they are randomly distributed.

When a matrix has a known pattern and distribution, this may be unnecessary, or solvable by other means. However, there may be cases where the weight matrix is random generally, but with a different pattern in one layer or one part of a layer. In those cases, it may be beneficial to implement some form of element shuffling to make the matrix pattern random and uniform throughout. An inverse function or similar may be maintained to return the matrix to a prior configuration following permutation.

In some embodiments, the methods and processes described herein may be tied to a computing system of one or more computing devices. In particular, such methods and processes may be implemented as a computer-application program or service, an application-programming interface (API), a library, and/or other computer-program product.

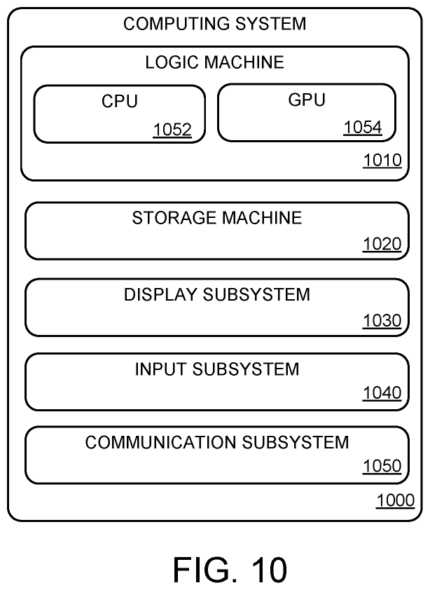

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices. Systems 100, 200 and 300 may be examples of computing system 1000.

Computing system 1000 includes a logic machine 1010 and a storage machine 1020. Computing system 1000 may optionally include a display subsystem 1030, input subsystem 1040, communication subsystem 1050, and/or other components not shown in FIG. 10.

Logic machine 1010 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

The logic subsystem may include one or more CPUs 1052 in addition to one or more GPUs 1054, and the one or more CPUs 1052 may be configured to send executable instructions and/or data to the one or more GPUs 1054. Responsive to processing of the instructions and/or data by the one or more GPUs 1054, the CPUs 1052 may receive result data from the one or more GPUs 1054. In this manner, the logic subsystem may execute a large number of computations in parallel via the GPUs. In particular, the logic subsystem may efficiently perform method 800 of FIG. 8.

The present disclosure refers to a GPU as a computing device well-suited for distributed learning processes, because a GPU is configured to execute a very large number of multiple replicated instances of the same program (e.g., a GPU kernel) in parallel, where each instance of the program receives and works on different input data. However, it is to be understood that other aspects of a logic subsystem may be configured to provide the same or similar benefits. As such, it is to be understood that any discussion of GPUs also applies to other suitable computing components, and the present disclosure is in no way limited to performing method 800, or any other aspect of training a machine-learning model on GPUs to the exclusion of other suitable computing devices.

Storage machine 1020 includes one or more physical devices configured to hold instructions executable by the logic machine to implement the methods and processes described herein. When such methods and processes are implemented, the state of storage machine 1020 may be transformed—e.g., to hold different data.

Storage machine 1020 may include removable and/or built-in devices. Storage machine 1020 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1020 may include volatile, nonvolatile, dynamic, static, read/write, read-only, random-access, sequential-access, location-addressable, file-addressable, and/or content-addressable devices.

It will be appreciated that storage machine 1020 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1010 and storage machine 1020 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 implemented to perform a particular function. In some cases, a module, program, or engine may be instantiated via logic machine 1010 executing instructions held by storage machine 1020. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service,” as used herein, is an application program executable across multiple user sessions. A service may be available to one or more system components, programs, and/or other services. In some implementations, a service may run on one or more server-computing devices.

When included, display subsystem 1030 may be used to present a visual representation of data held by storage machine 1020. This visual representation may take the form of a graphical user interface (GUI). As the herein described methods and processes change the data held by the storage machine, and thus transform the state of the storage machine, the state of display subsystem 1030 may likewise be transformed to visually represent changes in the underlying data. Display subsystem 1030 may include one or more display devices utilizing virtually any type of technology. Such display devices may be combined with logic machine 1010 and/or storage machine 1020 in a shared enclosure, or such display devices may be peripheral display devices.

When included, input subsystem 1040 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1050 may be configured to communicatively couple computing system 1000 with one or more other computing devices. Communication subsystem 1050 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

In one example, a method for sparse matrix multiplication comprises receiving a first block of elements having M elements in a first dimension, where M is an integer; parsing the first block of elements into a first set of B sub-blocks, where B is an integer <=M, and where each of the first set of B sub-blocks include MB elements in the first dimension; applying a first sparsity mask having S % sparsity over M elements to the first block of elements, such that each of the first set of B sub-blocks has S % sparsity; receiving a second block of elements having M elements in a second dimension, different than the first dimension; parsing the second block of elements into a second set of B sub-blocks, each of the second set of B sub-blocks including MB elements in the second dimension; applying a second sparsity mask having S′% sparsity over M elements to the second block of elements, such that S′% of the second set of B sub-blocks have 100% sparsity and (100−S′)% of the second set of B sub-blocks have 0% sparsity; and matrix multiplying the first block and second block. In such an example, or any other example, S is additionally or alternatively equal to S′. In any of the preceding examples, or any other example, one or more of the first sparsity mask and the second sparsity mask are additionally or alternatively generated based on a set of lowest one-norms for a respective set of MB elements. In any of the preceding examples, or any other example, one or more of the first sparsity mask and the second sparsity mask are additionally or alternatively generated based on absolute magnitudes for a respective set of MB elements. In any of the preceding examples, or any other example, the first block of elements is additionally or alternatively derived from a weight matrix, and the second block of elements is additionally or alternatively derived from an activation matrix. In any of the preceding examples, or any other example, the sparse matrix multiplication additionally or alternatively occurs during training of a neural network. In any of the preceding examples, or any other example, the first sparsity mask and second sparsity mask are additionally or alternatively dynamically recomputed for each iteration of training of the neural network. In any of the preceding examples, or any other example, the sparse matrix multiplication additionally or alternatively occurs during an inference operation of a trained neural network. In any of the preceding examples, or any other example, the first sparsity mask is additionally or alternatively maintained during each iteration of the inference operation, and the second sparsity mask is additionally or alternatively dynamically recomputed for each forward phase of the inference operation. In any of the preceding examples, or any other example, the sparse matrix multiplication additionally or alternatively occurs within a self-attention layer of a transformer language model, and wherein the first block of elements and second block of elements are both derived from activation matrices. The technical effect of implementing this method is an improvement in the use of computing resources.

In another example, a computing system for implementing a deep neural network comprises one or more logic machines; and one or more storage machines, each storage machine holding instructions, that when executed by the one or more logic machines cause the computing system to receive a first block of elements having M elements in a first dimension, where M is an integer; parse the first block of elements into a first set of B sub-blocks, where B is an integer <=M, and where each of the first set of B sub-blocks include MB elements in the first dimension; apply a first sparsity mask having S % sparsity over M elements to the first block of elements, such that each of the first set of B sub-blocks has S % sparsity; receive a second block of elements having M elements in a second dimension different than the first dimension; parse the second block of elements into a second set of B sub-blocks, each of the second set of B sub-blocks including M/B elements in the second dimension; apply a second sparsity mask having that has S′% sparsity over M elements to the second block of elements, such that S′% of the second set of B sub-blocks have 100% sparsity and (100−S′)% of the second set of B sub-blocks have 0% sparsity; and matrix multiply the first block and second block. In such an example, or any other example, S is additionally or alternatively equal to S′. In any of the preceding examples, or any other example, one or more of the first sparsity mask and the second sparsity mask are additionally or alternatively generated based on a set of lowest one-norms for a respective set of M/B elements. In any of the preceding examples, or any other example, the first block of elements is additionally or alternatively derived from a weight matrix, and the second block of elements is additionally or alternatively derived from an activation matrix, the weight matrix and activation matrix used as inputs to a sparse matrix multiplication. In any of the preceding examples, or any other example, the sparse matrix multiplication additionally or alternatively occurs during training of a neural network. In any of the preceding examples, or any other example, the first sparsity mask and second sparsity mask are additionally or alternatively dynamically recomputed for each iteration of training of the neural network. In any of the preceding examples, or any other example, the sparse matrix multiplication additionally or alternatively occurs during an inference operation of a trained neural network. In any of the preceding examples, or any other example, the first sparsity mask is additionally or alternatively maintained during each iteration of the inference operation, and the second sparsity mask is additionally or alternatively dynamically recomputed for each forward phase of the inference operation. In any of the preceding examples, or any other example, the sparse matrix multiplication additionally or alternatively occurs within a self-attention layer of a transformer language model, and the first block of elements and second block of elements are additionally or alternatively both derived from activation matrices. The technical effect of implementing this computing system is a reduction in computing costs in training and implementation of machine learning models.

In yet another example, a method for training a deep neural network comprises receiving a first block of elements derived from a weight matrix, the first block of elements having M elements in a first dimension, where M is an integer; parsing the first block of elements into a first set of B sub-blocks, where B is an integer M, and where each of the first set of B sub-blocks include MB elements in the first dimension; applying a first sparsity mask having S % sparsity over M elements to the first block of elements, such that each of the first set of B sub-blocks has S % sparsity; receiving a second block of elements derived from an activation matrix, the second block of elements having M elements in a second dimension different than the first dimension; parsing the second block of elements into a second set of B sub-blocks, each of the second set of B sub-blocks including MB elements in the second dimension; applying a second sparsity mask having S′% sparsity over M elements to the second block of elements, such that S′% of the second set of B sub-blocks have 100% sparsity and (100−S′)% of the second set of B sub-blocks have 0% sparsity; matrix multiplying the first block and second block; and dynamically recomputing the first sparsity mask and the second sparsity mask for each iteration of training of the neural network. The technical effect of implementing such a method is a reduction in the amount of computing resources utilized in training the neural network.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for sparse matrix multiplication, comprising:
receiving a first block of elements having M elements in a first dimension, where M is an integer;
parsing the first block of elements into a first set of B sub-blocks, where B is an integer <=M, and where each of the first set of B sub-blocks include MB elements in the first dimension;
applying a first sparsity mask having S % sparsity over M elements to the first block of elements, such that each of the first set of B sub-blocks has S % sparsity;
receiving a second block of elements having M elements in a second dimension, different than the first dimension;
parsing the second block of elements into a second set of B sub-blocks, each of the second set of B sub-blocks including MB elements in the second dimension;
applying a second sparsity mask having S′% sparsity over M elements to the second block of elements, such that S′% of the second set of B sub-blocks have 100% sparsity and (100−S′)% of the second set of B sub-blocks have 0% sparsity; and
matrix multiplying the first block and second block.

2. The method of claim 1, wherein S=S′.

3. The method of claim 1, wherein one or more of the first sparsity mask and the second sparsity mask are generated based on a set of lowest one-norms for a respective set of MB elements.

4. The method of claim 1, wherein one or more of the first sparsity mask and the second sparsity mask are generated based on absolute magnitudes for a respective set of MB elements.

5. The method of claim 1, wherein the first block of elements is derived from a weight matrix, and wherein the second block of elements is derived from an activation matrix.

6. The method of claim 5, wherein the sparse matrix multiplication occurs during training of a neural network.

7. The method of claim 6, wherein the first sparsity mask and second sparsity mask are dynamically recomputed for each iteration of training of the neural network.

8. The method of claim 5, wherein the sparse matrix multiplication occurs during an inference operation of a trained neural network.

9. The method of claim 8, wherein the first sparsity mask is maintained during each iteration of the inference operation, and wherein the second sparsity mask is dynamically recomputed for each forward phase of the inference operation.

10. The method of claim 1, wherein the sparse matrix multiplication occurs within a self-attention layer of a transformer language model, and wherein the first block of elements and second block of elements are both derived from activation matrices.

11. A computing system for implementing a deep neural network, comprising:
one or more logic machines; and
one or more storage machines, each storage machine holding instructions, that when executed by the one or more logic machines cause the computing system to:
receive a first block of elements having M elements in a first dimension, where M is an integer;
parse the first block of elements into a first set of B sub-blocks, where B is an integer <=M, and where each of the first set of B sub-blocks include MB elements in the first dimension;
apply a first sparsity mask having S % sparsity over M elements to the first block of elements, such that each of the first set of B sub-blocks has S % sparsity;
receive a second block of elements having M elements in a second dimension different than the first dimension;
parse the second block of elements into a second set of B sub-blocks, each of the second set of B sub-blocks including MB elements in the second dimension;
apply a second sparsity mask having that has S′% sparsity over M elements to the second block of elements, such that S′% of the second set of B sub-blocks have 100% sparsity and (100−S′)% of the second set of B sub-blocks have 0% sparsity; and
matrix multiply the first block and second block.

12. The computing system of claim 11, wherein S=S′.

13. The computing system of claim 11, wherein one or more of the first sparsity mask and the second sparsity mask are generated based on a set of lowest one-norms for a respective set of MB elements.

14. The computing system of claim 11, wherein the first block of elements is derived from a weight matrix, and wherein the second block of elements is derived from an activation matrix, the weight matrix and activation matrix used as inputs to a sparse matrix multiplication.

15. The computing system of claim 14, wherein the sparse matrix multiplication occurs during training of a neural network.

16. The computing system of claim 15, wherein the first sparsity mask and second sparsity mask are dynamically recomputed for each iteration of training of the neural network.

17. The computing system of claim 14, wherein the sparse matrix multiplication occurs during an inference operation of a trained neural network.

18. The computing system of claim 17, wherein the first sparsity mask is maintained during each iteration of the inference operation, and wherein the second sparsity mask is dynamically recomputed for each forward phase of the inference operation.

19. The computing system of claim 14, wherein the sparse matrix multiplication occurs within a self-attention layer of a transformer language model, and wherein the first block of elements and second block of elements are both derived from activation matrices.

20. A method for training a deep neural network, comprising:
receiving a first block of elements derived from a weight matrix, the first block of elements having M elements in a first dimension, where M is an integer;
parsing the first block of elements into a first set of B sub-blocks, where B is an integer <=M, and where each of the first set of B sub-blocks include MB elements in the first dimension;
applying a first sparsity mask having S % sparsity over M elements to the first block of elements, such that each of the first set of B sub-blocks has S % sparsity;
receiving a second block of elements derived from an activation matrix, the second block of elements having M elements in a second dimension different than the first dimension;
parsing the second block of elements into a second set of B sub-blocks, each of the second set of B sub-blocks including MB elements in the second dimension;
applying a second sparsity mask having S′% sparsity over M elements to the second block of elements, such that S′% of the second set of B sub-blocks have 100% sparsity and (100−S′)% of the second set of B sub-blocks have 0% sparsity;
matrix multiplying the first block and second block; and
dynamically recomputing the first sparsity mask and the second sparsity mask for each iteration of training of the neural network.
